(19) United States
(12) Patent Application Publication
(10) Pub. No.: US 2004/0232298 A1
(43) Pub. Date: Nov. 25, 2004

(54) Flat panel display mounting system

(76) Inventors: Jeff Bremmon, Shakopee, MN (US); Bruce Laughton, Shakopee, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/821,395

(22) Filed: Apr. 9, 2004

Related U.S. Application Data
(60) Provisional application No. 60/462,411, filed on Apr. 11, 2003.

(51) Int. Cl. A47F 5/00; F16M 13/00; G09G 5/00

(52) U.S. Cl. 248/281.11; 248/397; 248/917; 361/681

(57) ABSTRACT

A mounting system for connecting a flat panel display to a fixed structure, such as a building wall or ceiling, or display structure, includes a plurality of fastening buttons and a corresponding display connecting portion having keyhole slots. Each keyhole slot has an access hole and a notch. The fastening buttons are seated in the keyhole slots to hold the flat panel display adjacent the display connecting portion of the mounting system. The button has a head portion, a base portion, and a throat portion, the base portion preferably having a beveled region so that the device is self-aligning or self-guiding. At least part of the display connecting member adjacent the access hole may be ramped.

### RELATED APPLICATIONS

This application claims the benefit of U.S. Provisional Patent Application Ser. No. 60/462,411 filed Apr. 11, 2003, the same being hereby fully incorporated herein by reference.

### FIELD OF THE INVENTION

The present invention relates mounting systems for flat panel display devices, and in particular, to a mounting system suited for mounting a plasma flat panel display to a fixed structure.

### BACKGROUND OF THE INVENTION

Flat panel displays have become an increasingly popular substitute for television tubes and computer CRT's (cathode ray tubes). Flat panel displays are typically mounted on a structure, such as a wall, and ideally the angle of the flat panel display relative to vertical can be adjusted for optimum viewing. Various positioning devices have been used, such as friction based hinges, mechanical linkages with springs or other biasing devices, and various mechanical latches.

A particular type of flat panel display known as a “plasma” display is particularly popular for large screen display devices. Large plasma displays present unique challenges in the design of mounting systems.

Some plasma displays can be especially sensitive to radio frequency (RF) interference. Prior mounting systems are often made from metal and are attached directly to the display with metal fastening devices. The metal mounting system can act as an antenna, transmitting the RF interference to the display through the metal fastening devices, leading to poor or degraded display performance.

Also, plasma displays are often heavy and therefore difficult to lift and attach to a mounting system. In addition, because of the nature of plasma displays and the frequent desire to mount them as tightly to a structure as possible, attaching a display to a mounting system may have to be done more by touch or feel than by sight. Many prior mounting systems are cumbersome to use, and require two persons or even three persons to align and attach the display.

What is needed in the industry is a mounting system for a flat panel display, especially a plasma display that meets the aforementioned challenges.

### SUMMARY OF THE INVENTION

The present invention substantially meets the aforementioned needs of the industry. In the invention, electrically non-conductive or insulating fastening buttons are used to removably attach a flat panel display to a support structure. The flat panel display is thus isolated from any RF or other electrical interference that may be picked up in the support structure.

The fastening buttons are engaged in keyhole shaped slots having an access portion with a periphery and a notch in the periphery. The fastening buttons are shaped, and the keyhole slots are adapted, so that the buttons are self-guiding into engagement with the notch once the head of the button is received in the access portion. In addition, a ramped region may be provided opposite the notch, so that when the buttons are disengaged from the notch, the head of the button is inhibited from catching on the periphery of the slot. In addition, the button is urged outwardly, away from the slot as it rides on the ramped region. This combination of features eases engagement and disengagement of the display from the mounting system and makes the system correspondingly easier to use by an individual.

Accordingly, a mounting system for connecting a flat panel display to a fixed structure, such as a building wall or ceiling, or display structure, includes a plurality of fastening buttons and a corresponding display connecting portion having keyhole slots. Each keyhole slot has an access hole and a notch. The fastening buttons are seated in the keyhole slots to hold the flat panel display adjacent the display connecting portion of the mounting system. The button has a head portion, a base portion, and a throat portion, the base portion preferably having a beveled region so that the device is self-aligning or self-guiding. At least part of the display connecting member adjacent the access hole may be ramped.

The mounting system may be substantially electrically nonconductive or insulating so that an electrical charge or RF interference cannot flow from the mounting system into a flat panel display and vice versa. Also, the fastening buttons may provide sufficient space between the flat panel display and the other portions of the mounting system for air to circulate to help cool the display and prevent moisture from accumulating behind it. The mounting system is constructed and arranged so that the fastening buttons can be easily seated in and removed from the keyhole in one smooth motion. Moreover, the fastening buttons are constructed and arranged to be self-aligning or self-guiding as it is seated in the keyhole. Further, the keyhole slots may be arranged so that when a flat panel display is being attached to the mounting system, the display is self-aligning and preferably can be selectively mounted in either a horizontal or a vertical position.

### BRIEF DESCRIPTION OF THE DRAWINGS

FIG. 1 is a perspective view of a mounting system with a flat panel display depicted in phantom lines;

FIG. 2 is a perspective view of an adjustable mounting system with a display connecting portion according to the present invention;

FIG. 3 is a side elevation view of the mounting system of FIG. 2 with a flat panel display attached;

FIG. 3A is a side elevation view of a display connecting portion attached directly to a fixed structure;

FIG. 4 is a front elevation view of a display connecting portion according to the present invention;

FIG. 4A is a front elevation view of an alternative embodiment of a display connecting portion according to the present invention;

FIG. 4B is a front elevation view of another alternative embodiment of a display connecting portion according to the present invention;

FIG. 5 is an enlarged view of a keyhole slot according to the present invention;

FIG. 5A is an enlarged view of another embodiment of a keyhole slot according to the present invention;

FIG. 6 is an enlarged view of a keyhole slot according to the present invention depicting various positions of a fastening button in the keyhole slot during a process of engaging and disengaging the fastening button;

FIG. 6A is a cross-sectional view taken through section 6A-6A of FIG. 6;

FIG. 7 is a perspective view of a fastening button;

FIG. 7A is a perspective view of an alternative embodiment of a fastening button;

FIG. 7B is a perspective view of another alternative embodiment of a fastening button;

FIG. 8 is a side elevation of the fastening button of FIG. 7;

FIG. 8A is a side elevation of the fastening button of FIG. 7A;

FIG. 8B is a side elevation of an alternative embodiment of a fastening button;

FIG. 8C is a side elevation of another alternative embodiment of a fastening button; and

FIG. 9 is a top plan view of the button of FIG. 7.

### DETAILED DESCRIPTION OF THE PREFERRED EMBODIMENTS

The present invention relates to a mounting system for connecting a flat panel display to a fixed structure, and particularly a system adapted for and/or intended to be used with a flat panel display. A flat panel display includes a plasma display, a liquid crystal display, or any present or future kind of display that is similarly relatively flat or having a relatively minimal depth dimension. Use of the term “flat panel display” is intended to include a plate attached to the flat panel display to adapt the display for being held to a mounting system using the present invention. A mounting system is intended to include a mount against any stable surface such as a wall or ceiling or any other surface stable enough to hold the mount and the desired flat panel display, which combined weight often exceeds 150 pounds. The term “display connecting member” is intended to include all those parts of a mounting system to which a flat panel display is held using the present invention. A fixed structure includes any portion of a building or other similar permanent or temporary structure, portable support structures such as trade show booths, and any other object or structure to which a display device may be attached.

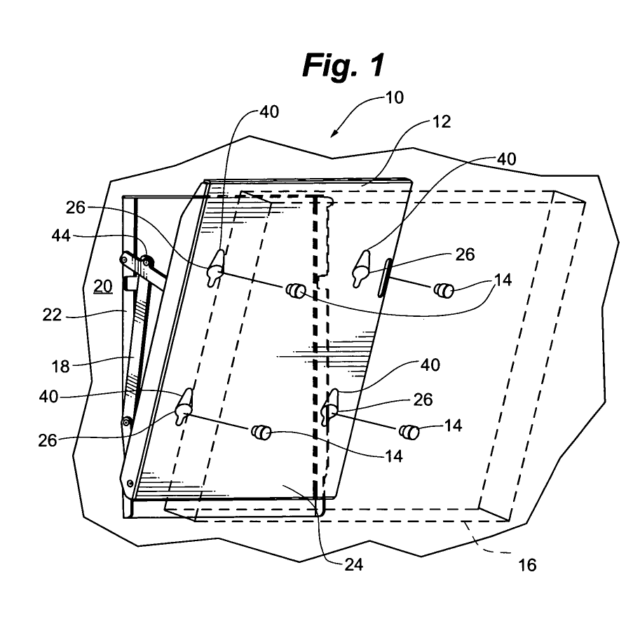

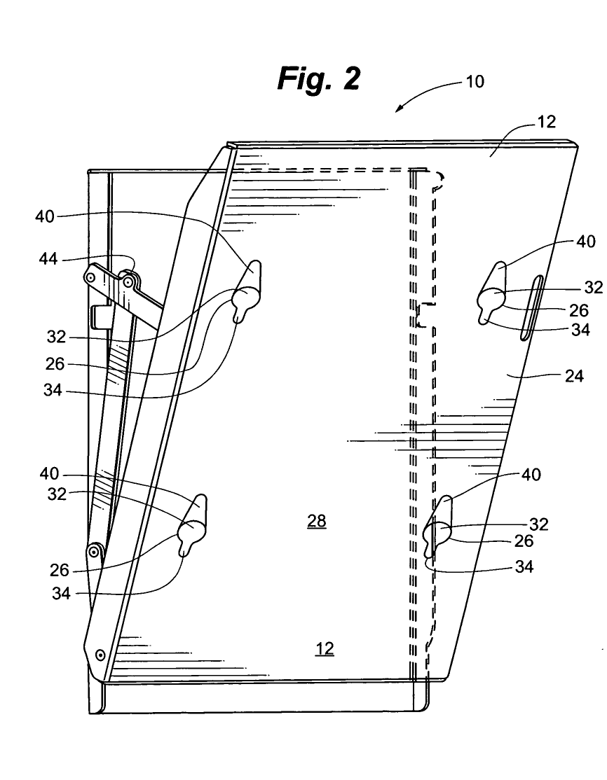

A display mounting system 10 according to the present invention is depicted in FIGS. 1-3. Display mounting system 10 generally includes a display connecting member 12 and a plurality of fastening buttons 14. Generally, as depicted in FIG. 1, fastening buttons 14 attach to a flat panel display 16. Display connecting member 12 attaches to a support structure 18, which may include a fixed structure 20 and a mounting bracket assembly 22. As will be explained in detail hereinbelow, fastening buttons 14 engage with display connecting member 12 so as to attach flat panel display 16 to fixed structure 20.

Display connecting member 12 has a generally planar body portion 24 with a plurality of keyhole slots 26, each for engaging one of fastening buttons 14. Body portion 24 has a front surface 28 and a back surface 30. Each keyhole slot 26 has a generally round access portion 32, having a maximum dimension annotated D₁ in the drawings. A notch 34 is formed in periphery 36 of access portion 32. A button seating region 38 surrounds notch 34. Display connecting member 12 has a thickness dimension, annotated T₁ in the drawings, at each button seating region 38. Notch 34 has a width, annotated W₁ in the drawings.

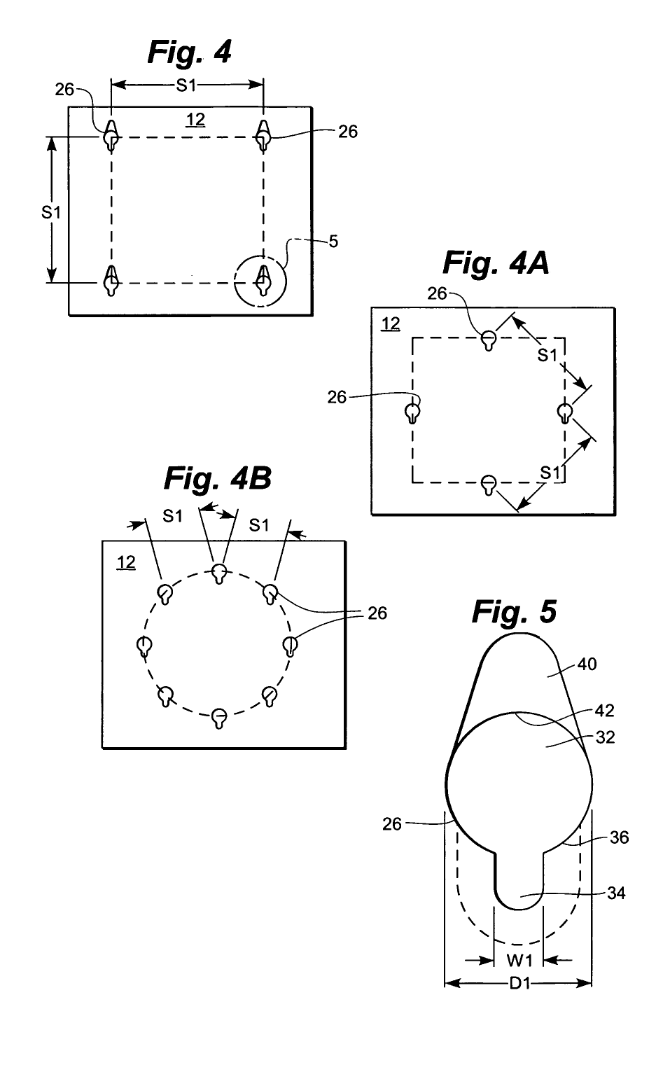

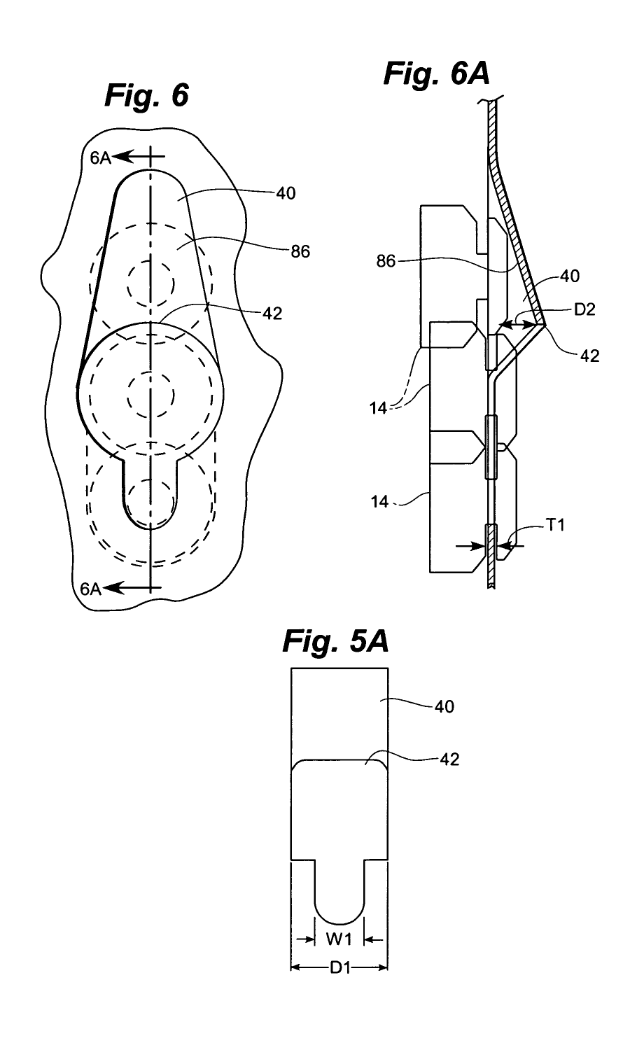

As will be readily appreciated, keyhole slot 26 may be a conventional keyhole shape as depicted in FIG. 5, or may be made in any other suitable shape, such as the squared shape depicted in FIG. 5A. Also, the keyhole slots 26 may be arranged on display connecting member 12 in a variety of configurations. It is generally preferred that the keyhole slots be arranged in a square or circular pattern with a substantially equal spacing S₁ as depicted in FIGS. 4-4B, so that a rectangular or square display may be interchangeably affixed in at least a vertical orientation known as a “portrait” orientation, or a horizontal orientation, known as a “landscape” orientation.

Display connecting member 12 may have a ramped region 40 adjacent, and extending away from, keyhole slot 26 opposite notch 34. The lower edge 42 of ramped region 40 is set inwardly from back surface 30 by a distance, annotated D₂ in the drawings.

It is contemplated that display connecting member 12 may be attached to any support structure 18 suitable for supporting the weight of the member and an attached display, including any adjustable mounting system apparatus. In the embodiment depicted in FIGS. 1-3, an adjustable mounting system 44 is provided. Adjustable mounting system 44 is substantially similar in structure and operation to the system described in U.S. Pat. No. 6,402,109, commonly assigned to the owners of the present invention, said patent being hereby fully incorporated herein by reference.

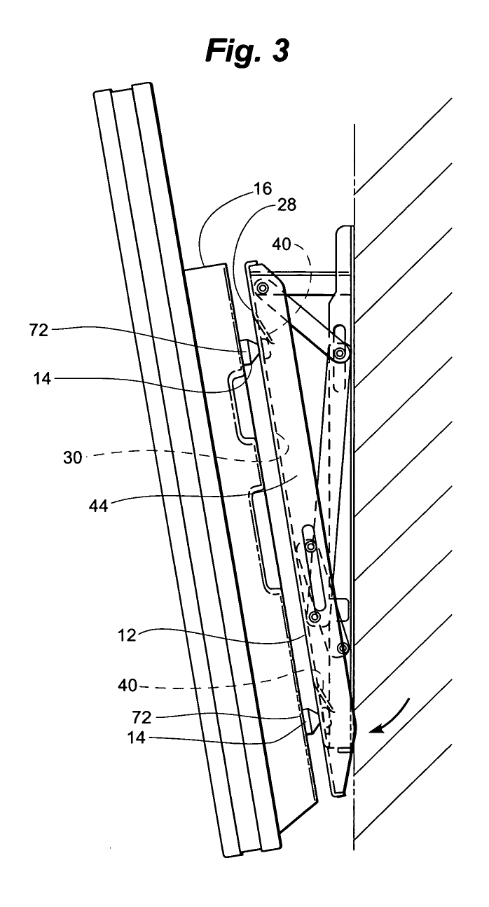

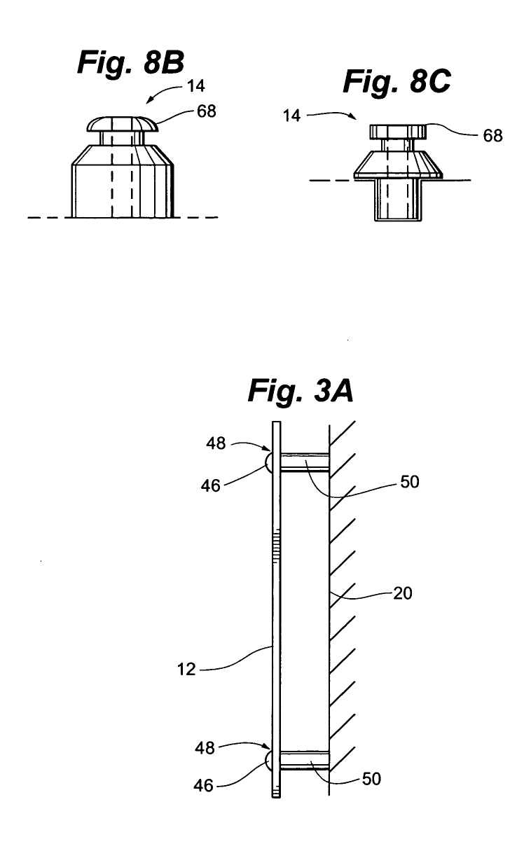

It is specifically contemplated that the present invention is suitable for use with any other mounting apparatus for coupling a flat panel display with a surface, including such tilt mechanisms, swing arm arrangements, and pivoting mounts as are commonly known in the art. Also, display connecting member 12 may be secured directly to a fixed surface as depicted in FIG. 3A. In this embodiment, fasteners 46 extend through apertures 48 in display connecting member 12, through spacers 50 and into the fixed structure 20.

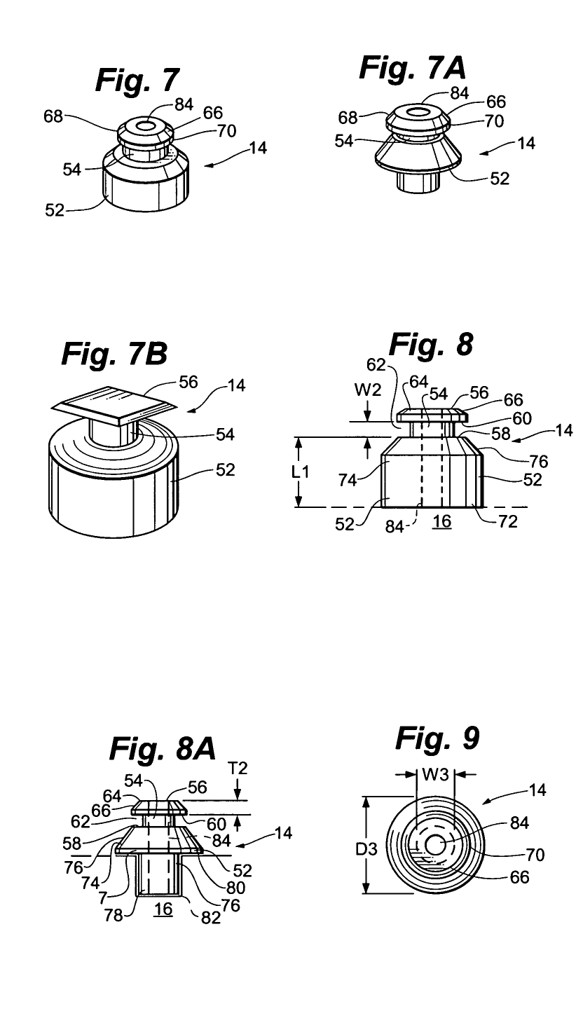

As depicted in FIGS. 7-9, fastening buttons 14 have a generally columnar structure with a base portion 52, a throat portion 54 and a head portion 56. Upper surface 58 of base portion 52 and lower surface 60 of head portion 56 define a slot 62 therebetween at throat portion 54. Slot 62 has a width dimension, annotated W₂ in the drawings, selected so as to be slightly greater than thickness T₁ of button receiving region 38 of display connecting member 12. In addition, throat portion 54 has a cross-sectional dimension, annotated W₃ in the drawings, slightly smaller than width W₁ of notch 34, so that throat portion 54 is receivable in notch 34. Button receiving region 38 generally corresponds to the area covered by head portion 56 when fastening button 14 is engaged in notch 34. When throat portion 54 of fastening button 14 is thus received in notch 34, upper surface 58 of base portion 52 confronts front surface 28 and lower surface 60 confronts back surface 30, with button seating region 38 captured between upper surface 58 and lower surface 60.

Head portion 56 is disposed at distal end 64 of fastening button 14. Head portion 56 has a generally flat, disc like shape, and has a maximum dimension, annotated D₃ in the drawings. Maximum dimension D₃ is selected so as to be less than maximum dimension D₁ of access portion 32, and greater than width W₁ of notch 34, so that head portion 56 will pass through access portion 32, but not notch 34. The thickness dimension of head portion 56, annotated T₂ in the drawings, is selected so as to be less than distance D₂ by which the lower edge 42 of ramped region 40 is set back from back surface 30. A beveled portion 66 may be provided at the top edge 68 of perimeter 70 of head portion 56. As an alternative, top edge 68 may also be generally rounded off or left square with no rounding or beveling as depicted in FIGS. 8B and 8C respectively.

Also, as an alternative to the round head shape depicted in FIGS. 7 and 7A, it is contemplated that other head shapes may be used within the scope of the invention. In one example, a square shape such as depicted in FIG. 7B may be used. Other examples may include other polygonal shapes such as a triangle, rectangle, pentagon, hexagon, and the like. It will be appreciated that, in any such embodiments, the dimensions of the head portion 56 must enable it to pass through the access portion 32 but not notch 34 of keyhole slot 26.

Base portion 52 is disposed at proximal end 72 and has a shank portion 74, with a maximum dimension, annotated D₃ in the drawings. Maximum dimension D₃ is preferably larger than maximum dimension D₁ of access portion 32, so that shank portion 74 will not pass through keyhole slot 26. Shank portion 74 preferably has a beveled region 76. Shank portion 74 may also have a projecting portion 78 on bottom surface 80 for engaging a suitable recess 82 in a display. The overall length of base portion 52, annotated L₁ in the drawings, may be selected to provide any amount of spacing of display connecting member 12 from display 16 that is needed or desired to enhance the electrical properties of the fastening button 14, and for air circulation between the flat panel display 16 and the mounting system.

The dimensions and material used for fastening button 14 may be optimized using standard engineering design methods, so as to have appropriate stress resistance and fatigue properties. Preferably, fastening button 14 is formed from material that is substantially electrically non-conductive or insulating. It is presently preferred that fastening button 14 be made from nylon 6-6 or PVC, but any other relatively non-conductive polymer materials may also be used.

As depicted in FIGS. 3, 8A, and 8B, fastening buttons 14 are preferably attached to the display 16, with proximal end 74 abutting display 16, and with distal end 64 extending outwardly therefrom. Fastening button 14 may be attached to display 16 by any suitable method such as a bolt or screw (not depicted) extending through bore 84, glue or other adhesive, a heat process, or friction fitting projecting portion 78 into recess 82, which may also be a slot or aperture. It is also contemplated that fastening button 14 may be integrally formed with display 16.

In operation, to connect the display 16 to display connecting member 12 and any support structure 18 or fixed structure 20 connected therewith, the display 16 is positioned as depicted in FIG. 1 so that each of the plurality of fastening buttons 14 is positioned proximate a separate one of keyhole slots 26. The head portion 56 of each fastening button 14 is positioned through access portion 32 of the corresponding keyhole slot 26. Beveled region 76 of shank portion 74 may engage the periphery 36 of access portion 32, preventing fastening button 14 from moving further into keyhole slot 26. As the display is moved downwardly, beveled region 76 rides on periphery 36, so that slot 62 engages in notch 34 with head portion 56 and base portion 52 on opposite sides of display connecting member 12. Thus, display 16 is held on display connecting member 12 by engagement of fastening button 14 in keyhole slot 26.

To remove display 16 from display connecting member 12, the display is lifted upwardly so that slot 62 is disengaged from notch 34. Lower edge 42 of ramped portion 40 is set back from back surface 30 a greater distance than the thickness of head portion 56, as previously explained. Accordingly, head portion 56 does not catch on lower edge 42, but instead, as display 16 is lifted further upward, beveled portion 66 of head portion 56 contacts inner surface 86 of ramped region 40, and begins to ride upwardly along it as depicted in FIGS. 6 and 6A, also moving outwardly due to the sloping of ramped region 40. Display 16 is thus detached in a relatively smooth motion, and without catching slot 62 on any part of the periphery 36 of keyhole slot 26.

Although the preferred embodiment and alternative embodiment(s) of a device for connecting a flat panel display to a wall mount system have been described herein, it should be recognized that numerous changes and variations can be made to these embodiments and still be within the spirit of the present invention. For example, fastening buttons 14 may be attached to the display connecting member 12 of the mounting system and the corresponding keyhole slots 26 may be in and/or a part of the flat panel display 16, with an accompanying interchange of all other appropriate structure (e.g., notch 34 is above access portion 32 when keyhole slots 26 are formed in display 16 and the fastening buttons are attached to display connecting member 12).

What is claimed is:

1. A mounting system for detachably coupling a pair of bodies, a first one of said pair of bodies including a flat panel display device, a second one of said pair of bodies including a fixed structure, the system comprising:
a plurality of fastening buttons adapted to be operably coupled to one of said pair of bodies, each fastening button having a base portion, a head portion, and a throat portion therebetween; and
a display connecting portion adapted to be operably coupled to the other of said pair of bodies and having a plurality of keyhole slots defined therein for receiving and engaging the fastening buttons, each keyhole slot having an access portion adapted to receive the head portion of one of said fastening buttons therethrough, said access portion having a periphery and a notch in the periphery for receiving and engaging the throat portion of the fastening button, said display connecting portion further having a ramped region extending from the periphery of the access portion of each keyhole slot in a direction opposite the notch, wherein said ramped region has an inner surface adapted to engage and guide the head portion of the fastening button when the fastening button is disengaged from the keyhole slot.

2. The system of claim 1, wherein said fastening buttons are formed from a substantially electrically insulating material.

3. The system of claim 2, wherein said material is Nylon 6-6 or PVC.

4. The system of claim 1, wherein said fastening buttons are operably coupled to the first one of said pair of bodies and said display connecting portion is operably coupled to the second one of said pair of bodies.

5. The system of claim 4, wherein the second one of said pair of bodies includes an adjustable mounting system operably coupled with said fixed structure, and wherein said display connecting portion is operably coupled with said adjustable mounting system.

6. The system of claim 1, wherein said fastening buttons are operably coupled to the second one of said pair of bodies, and said display connecting portion is operably coupled to the first one of said pair of bodies.

7. The system of claim 6, wherein the second one of said pair of bodies includes an adjustable mounting system operably coupled with said fixed structure, and wherein said fastening buttons are operably coupled with said adjustable mounting system.

8. The system of claim 1, wherein said keyhole slots are arranged in a polygonal or circular pattern, each said keyhole slot being spaced a substantially equal distance from each adjacent keyhole slot.

9. The system of claim 8, wherein the flat panel display can be selectively interchangeably oriented in at least a horizontal and a vertical orientation.

10. A mounting system for detachably coupling a pair of bodies, a first one of said pair of bodies including a flat panel display device, a second one of said pair of bodies including a fixed structure, the system comprising:
a plurality of fastening buttons adapted to be operably coupled to one of said pair of bodies, each fastening button having a base portion, a head portion, and a throat portion therebetween; and
a display connecting portion adapted to be operably coupled to the other of said pair of bodies and having a plurality of keyhole slots defined therein for receiving and engaging the fastening buttons, each keyhole slot having an access portion adapted to receive the head portion of one of said fastening buttons therethrough, said access portion having a periphery and a notch in the periphery for receiving and engaging the throat portion of the fastening button, said display connecting portion further having means for engaging and guiding the head portion of the fastening button when the fastening button is disengaged from the keyhole slot.

11. The system of claim 10, wherein said fastening buttons are formed from a substantially electrically insulating material.

12. The system of claim 1 1, wherein said material is Nylon 6-6 or PVC.

13. The system of claim 10, wherein said fastening buttons are operably coupled to the first one of said pair of bodies and said display connecting portion is operably coupled to the second one of said pair of bodies.

14. The system of claim 13, wherein the second one of said pair of bodies includes an adjustable mounting system operably coupled with said fixed structure, and wherein said display connecting portion is operably coupled with said adjustable mounting system.

15. The system of claim 10, wherein said fastening buttons are operably coupled to the second one of said pair of bodies, and said display connecting portion is operably coupled to the first one of said pair of bodies.

16. The system of claim 15, wherein the second one of said pair of bodies includes an adjustable mounting system operably coupled with said fixed structure, and wherein said fastening buttons are operably coupled with said adjustable mounting system.

17. The system of claim 10, wherein said keyhole slots are arranged in a polygonal or circular pattern, each said keyhole slot being spaced a substantially equal distance from each adjacent keyhole slot.

18. The system of claim 17, wherein the flat panel display can be selectively interchangeably oriented in at least a horizontal and a vertical orientation.

19. A method for detachably coupling a pair of bodies, a first one of said pair of bodies including a flat panel display device, a second one of said pair of bodies including a fixed structure, the method comprising the steps:
attaching a plurality of electrically non-conductive fastening buttons to one of said pair of bodies, each fastening button having a base portion, a head portion, and a throat portion therebetween;
attaching a display connecting portion to the other of said pair of bodies, said display connecting portion having a plurality of keyhole slots defined therein for receiving and engaging the fastening buttons, each keyhole slot having an access portion adapted to receive the head portion of one of said fastening buttons therethrough, said access portion having a periphery and a notch in the periphery for receiving and engaging the throat portion of the fastening button; and
engaging said fastening buttons in said keyhole slots.

20. An electrically isolated flat panel display and mounting system attachable to a fixed structure comprising:
a flat panel display device;
a support structure adapted to be attached to the fixed structure;
a plurality of electrically non-conductive fastening buttons attached to the flat panel display device, each fastening button having a base portion, a head portion, and a throat portion therebetween;
a display connecting portion operably coupled to said support structure and having a plurality of keyhole slots defined therein for receiving and engaging the fastening buttons, each keyhole slot having an access portion adapted to receive the head portion of one of said fastening buttons therethrough, said access portion having a periphery and a notch in the periphery for receiving and engaging the throat portion of the fastening button.

21. The display and mounting system of claim 20, wherein said display connecting portion has a ramped region extending from the periphery of the access portion of each keyhole slot in a direction opposite the notch, and wherein said ramped region has an inner surface adapted to engage and guide the head portion of the fastening button when the fastening button is engaged and disengaged from the keyhole slot.

22. The system of claim 20, wherein said fastening buttons are formed from a substantially electrically insulating material.

23. The system of claim 22, wherein said material is Nylon 6-6 or PVC.

24. The system of claim 20, wherein said keyhole slots are arranged in a polygonal or circular pattern, each said keyhole slot being spaced a substantially equal distance from each adjacent keyhole slot.

25. The system of claim 24, wherein the flat panel display can be selectively interchangeably oriented in at least a horizontal and a vertical orientation.
